(19) United States
(12) Patent Application Publication
(10) Pub. No.: US 2007/0215612 A1
(43) Pub. Date: Sep. 20, 2007

(54) Apparatus and method for microwave processing of materials

(76) Inventors: Keith R. Hicks, Garner, NC (US); Iftikhar Ahmad, Raleigh, NC (US); Clayton R. DeCamillis, Raleigh, NC (US); Joseph M. Wander, Chapel Hill, NC (US); Zakaryae Fathi, Raleigh, NC (US)

Correspondence Address: ROBERT J. LAUF, 998 W. OUTER DRIVE, OAK RIDGE, TN, 37830, US

(21) Appl. No.: 11/384,672

(22) Filed: Mar. 20, 2006

(51) Int. Cl. H05B 6/74

(52) U.S. Cl. 219/746

(57) ABSTRACT

A microwave heating apparatus is designed to improve distribution of the microwaves introduced into a multi-mode microwave cavity for heating or other selected applications. The microwave heating apparatus includes a microwave signal generator and a waveguide to convey microwave power to the cavity. A perforated metal plate disposed within the cavity encloses a volume adjacent to the waveguide opening, forming a leaky multimode subcavity. Through multiple processes of reflection, transmission, diffraction, and scattering, the leaky subcavity serves to smooth the microwave power distribution in the near-field region adjacent to the waveguide to better disperse the energy throughout the main applicator cavity. A more uniform level of microwave power is thereby applied to the workpiece.

### BACKGROUND OF THE INVENTION

1. Field of the Invention

This invention relates to the field of microwave radiation. More specifically, this invention relates to a microwave furnace having improved heating uniformity throughout the applicator cavity by use of a leaky multimode subcavity within the main microwave cavity.

2. Background Art

In the field of microwave radiation, it is well known that microwave furnaces are typically constructed with a fixed operating frequency. Most microwave sources have a very narrow bandwidth because they employ a resonant cavity. Microwave ovens constructed for home use are provided with a magnetron that operates at 2.45 GHz, the frequency that has been allocated by the FCC for microwave heating and similar applications. Owing to the coupling ability of a 2.45 GHz microwave to water, these ovens are used for cooking foods, drying, and other purposes wherein the principal material to be acted upon is water. However, it is well known that a multimode cavity operating at fixed frequency will display significant non-uniformities in the spatial power density owing to the formation of standing waves (or the excitation of only a small number of microwave modes within the cavity).

Recently, the use of frequency sweeping over a wide range as a means of mode stirring has been disclosed by Bible et al. in U.S. Pat. No. 5,321,222. Modeling results and experimentation have shown that for typical multimode applicator cavities a bandwidth of about ±5% of a center frequency provides a relatively uniform power density because of the superposition of many independent microwave modes (Bible et al., U.S. Pat. No. 5,961,871). Electronic frequency sweeping may be performed at a high rate of speed, thereby creating a much more uniform time-averaged power density throughout the furnace cavity. The desired frequency sweeping may be accomplished through the use of a variety of microwave electron devices. A helix traveling wave tube (TWT), for example, allows the sweeping to cover a broad bandwidth (e.g., 2 to 8 GHz) compared to devices such as the voltage tunable magnetron (2.45±0.05 GHz). Other devices such as klystrons and gyrotrons have other characteristic bandwidths, which may be suitable for some applications.

In fixed frequency ovens, attempts have been made at mode stirring, or randomly deflecting the microwave “beam”, in order to break up the standing modes and thereby fill the cavity with the microwave radiation. One such attempt is the addition of rotating fan blades at the beam entrance of the cavity. Another method used to overcome the adverse effects of standing waves is to intentionally create a standing wave within a single-mode cavity such that the workpiece may be placed at the location determined to have the highest power (the hot spot). Thus, only that portion of the cavity in which the standing wave is most concentrated will be used. Other devices have been produced to change the parameters of the heating process of selected materials. Typical of the art are those devices disclosed in the following Table:

TABLE 1
Some Microwave Heating Approaches

| Pat. No. | Inventor(s) | Issue Date |
|---|---|---|
| 3,611,135 | D. L. Margerum | Oct. 5, 1971 |
| 4,144,468 | G. Mourier | Mar. 13, 1979 |
| 4,196,332 | A. MacKay B, et al. | Apr. 1, 1980 |
| 4,340,796 | M. Yamaguchi, et al. | Jul. 20, 1982 |
| 4,415,789 | T. Nobue, et al. | Nov. 15, 1983 |
| 4,504,718 | H. Okatsuka, et al. | Mar. 12, 1985 |
| 4,593,167 | O. K. Nilssen | Jun. 3, 1986 |
| 4,777,336 | J. Asmussen | Oct. 11, 1988 |
| 4,825,028 | P. H. Smith | Apr. 25, 1988 |
| 4,843,202 | P. H. Smith, et al. | Jun. 27, 1989 |
| 4,866,344 | R. I. Ross, et al. | Sep. 13, 1989 |
| 4,939,331 | B. Berggren, et al. | Jul. 3, 1990 |
| 5,321,222 | D. W Bible et al. | Jun. 14, 1994 |
| 5,961,871 | D. W Bible et al. | Oct. 5, 1999 |

As previously mentioned, Bible et al. have described how frequency sweeping over a selected bandwidth, typically 5%, could establish a substantially uniform microwave power distribution within the cavity by the superposition of many hundreds of microwave modes. However, Applicants later discovered that there are some deviations from the relatively uniform power distribution predicted by modeling and observed in simple cavity characterization tests. These discrepancies arise because of the fact that near-field effects exist within the applicator cavity in the vicinity of the waveguide entrance and in this region neither pure waveguide nor pure cavity behavior applies. The net result is that there is often an undesirable concentration of power immediately adjacent to the waveguide entrance. This effect becomes exaggerated if the cavity is relatively long (for instance, to accommodate a conveyor mechanism for transporting workpieces through the cavity) and the microwaves are introduced perpendicular to the long axis. Applicants have discovered, surprisingly, that a subcavity defined by a surface that is partially reflective and partially transmissive to microwave energy, surrounding the waveguide entrance, can be usefully employed to mitigate the aforementioned near-field effects, as an adjunct to previously described variable frequency microwave heating techniques. Applicants have further discovered, more surprisingly, that the inventive structure does not significantly affect efficiency as measured either by heating rate or by reflected power detected in the waveguide circuit. The inventive subcavity can take a number of forms:

In one form, a perforated metal sheet formed into a selected shape may be attached to the cavity wall, thereby enclosing the waveguide entrance and some volume of the main cavity and forming a multimode subcavity. (The perforations may be of any selected shape, but are preferably small compared to the wavelength of the microwave signal.) Microwave energy entering through the waveguide is partially reflected and scattered along the length of the perforated structure. This has the desired effect of spreading the power along the length of the cavity to mitigate near field effects. Furthermore, the microwave energy leaving the subcavity through the perforations enters the main cavity at many different angles, thereby contributing to the excitation of a more random distribution of microwave modes. This has the effects of creating a power distribution doser to the ideal distribution predicted by mathematical modeling and making the power distribution less sensitive to variations in load characteristics of the workpiece being heated.

In a second form, a perforated sheet that forms a boundary of the inventive subcavity may be affixed directly to the cavity wall or it may stand off a short distance from the wall, thereby forming a small gap through which additional microwave energy can exit into the main cavity.

In a third form, under some circumstances, the aforementioned concentration of energy directly in front of or below the waveguide entrance may be further suppressed by replacing a small portion of the perforated structure with a solid metal sheet. It will be appreciated, however, that there is a limit on how much of the perforated structure can be replaced with solid structure without adversely affecting efficiency.

In earlier work, the operation of the subcavity required sweeping the microwave frequency in a substantially continuous manner over some useful bandwidth, typically 5%, for example, in the MicroCure 5100A and 5100B products (Lambda Technologies, 860 Aviation Pkwy., Morrisville, N.C. 27560). It was believed at the time that frequency sweeping was essential to the operation of the leaky subcavity for obtaining better process uniformity, and the MicroCure™ 5100 was designed specifically for relatively wide bandwidth operation.

As previously mentioned, in fixed-frequency microwave ovens, rotating components are often used in an attempt to deflect the incoming microwave beam and improve uniformity. Other devices occasionally used in microwave applicators include slotted waveguides and impedance transformers (typically cylindrical or tapered transitions). The following discussion of these prior approaches is also illustrated schematically in FIG. 8, where the fundamental differences between both prior approaches and the inventive subcavity will be evident.

A slotted or waveguide applicator may be employed in one of several ways. In one form, microwave energy propagates along the waveguide while a workpiece to be processed (typically a thin continuous sheet, fiber, or the like) passes through the waveguide in a perpendicular direction through slots on opposite walls. In a second form, the workpiece to be processed is located within an applicator cavity as shown schematically in FIG. 8A. A waveguide containing one or more slots at selected points along its length is also located within the cavity. As microwave energy propagates in an orderly way along the waveguide, some fraction of the energy leaks out through the slots. The end of the waveguide may be terminated or it may also be open (as shown) to allow further microwave energy to come out into the cavity. Differences between the slotted waveguide applicator and the inventive leaky subcavity are summarized in Table 2 below.

Note that the mathematical analysis of a slotted waveguide rests on the assumption that the surrounding cavity has a very low Q factor so that the presence of a cavity outside the waveguide does not influence the microwave field in the waveguide itself. In the present circumstances, this assumption is not satisfied, making it impossible to model the performance of a leaky waveguide in the multimode cavities of interest here. However, the use of a slotted waveguide was investigated (as will be described later) and was found not to provide beneficial uniformity improvements, particularly as compared to the inventive structures.

TABLE 2
Comparison of Slotted Waveguides and Subcavities

| Slotted Waveguide | Subcavity |
|---|---|
| Generally fixed | Suitable for wide bandwidth, ideally Δf ≧5% f_{c} |
| frequency | |
| Power propagates ∥ | Power enters generally ⊥ to axis or wall (depending |
| to length of | on specific geometry) and undergoes multiple |
| waveguide and | reflection/scattering events, which serve to spread |
| exits ⊥ to direction | the power density ⊥ to original launch direction; |
| of original | power then leaks out through the subcavity wall in |
| propagation | many directions, in part ∥ to original launch |
| | direction. |

The impedance transformer (see, e.g., Bible et al. U.S. Pat. No. 5,961,871) comprises an expanded area between the end of the waveguide and the wall of the cavity as shown schematically in FIG. 8B. The transition serves as an impedance matching device to reduce the voltage standing wave ratio (VSWR) and improve the efficiency of coupling power into the cavity. This type of transition structure is not to be considered a “subcavity” in the sense in which the term is used herein; the differences between conventional transition structures and the inventive leaky subcavity are summarized in Table 3 below.

TABLE 3
Comparison of Impedance Transformers and Subcavities

| Impedance Transformer | Subcavity |
|---|---|
| Cavity of fixed dimensions outside of | Subdivision of main cavity defined by a leaky |
| main cavity | boundary |
| Completely open boundary surface | Leaky boundary comprising a conductor with |
| between waveguide and main cavity | sub-wavelength openings |
| Impedance matching device whose | Scattering reflective/transmissive structure |
| main function is to lower VSWR | whose function is to diffuse the radiated |
| | power and excite multiple modes more |
| | uniformly |
| Walls generally parallel and symmetrical | Walls may be nonparallel to make it difficult |
| about waveguide axis | for standing waves to be excited within the |
| | subcavity |
| Open surface generally parallel to | Perforated surface may be parallel or it may |
| entrance wall of main cavity | form some angle relative to entrance wall in |
| | order to further enhance randomness of |
| | modes |
| Open boundary generally >λ/2 | Conductive surface with a plurality of |
| | openings <λ/2 |

### OBJECTS AND ADVANTAGES

Objects of the present invention include: providing a microwave heating apparatus in which a workpiece may be subjected to a controlled application of microwave energy; providing a microwave heating apparatus in which various workpieces may be processed uniformly despite differences in their load characteristics; providing a microwave heating apparatus in which energy concentrations in the near vicinity of the waveguide entrance are minimized; providing a microwave heating apparatus in which a plurality of workpieces may be subjected to a more uniform application of microwave energy using a relatively lower cost microwave power source; providing a method of applying a controlled concentration of microwave energy to a workpiece of a desired size and shape; providing a method of uniformly processing a workpiece with microwave energy despite discontinuities on the workpiece itself; and, providing a method of microwave heating in which a leaky subcavity creates a relatively uniform power density within a microwave processing cavity when used with a relatively narrow bandwidth microwave generator.

Other objects and advantages will be accomplished by the present invention, which is designed to allow dispersion of the microwaves introduced into a furnace cavity for heating or other selected processes. Some applicable processes include cooking, heat treatment, sterilization, sintering, plasma processing, ore processing, polymerization, etching, and preparing films.

### SUMMARY OF THE INVENTION

According to one aspect of the invention, an apparatus for microwave processing of selected materials comprises: a microwave source having a selected frequency range of a few percent or less; a multimode applicator cavity; a transmission line from the microwave source to the microwave cavity, the transmission line including a waveguide opening into a first wall of the cavity; and, a metallic structure enclosing a selected volume of the cavity around the waveguide opening, the structure and the first wall defining the boundary of a multimode subcavity, the boundary surface being partially reflective and partially transmissive to microwave energy, whereby the microwave power may be introduced more uniformly into the applicator cavity.

According to another aspect of the invention, a method for microwave processing of selected materials comprises the steps of: (a) placing the material in a multimode microwave applicator cavity, the cavity containing a subcavity having a boundary that is partly reflective and partly transmissive to microwave energy; and, (b) introducing microwave energy having a bandwidth of a few percent or less into the subcavity from which the microwave energy can pass through the partially transmissive boundary and into the applicator cavity, whereby the material may be more uniformly exposed to microwave energy.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like reference numerals (if they occur in more than one view) designate the same elements. The features in the drawings are not necessarily drawn to scale.

FIG. 1 is a schematic diagram of a preferred embodiment of the microwave heating apparatus of the present invention, wherein a rectangular subcavity is defined by the back wall of the main cavity and a perforated metal sheet that forms the other three sides;

FIG. 2 illustrates a schematic diagram of another preferred embodiment of the microwave heating apparatus of the present invention in which the subcavity has a cylindrical surface;

FIG. 3 illustrates a schematic diagram of another preferred embodiment of the microwave heating apparatus of the present invention in which the subcavity is a trapezoidal prism;

FIG. 4 is a schematic diagram of another preferred embodiment of the microwave heating apparatus of the present invention, wherein a rectangular subcavity is defined by the back and top walls of the main cavity and a perforated metal sheet that forms the other two sides;

FIG. 5 illustrates the use of a solid deflector plate replacing a portion of the perforated wall of the subcavity;

FIG. 6 illustrates the formation of a triangular subcavity using a single flat metal plate whereby leakage is controlled by changing the angle and the gaps between the plate and the walls of the main cavity.

FIG. 7 illustrates some typical patterns of perforations that have been used in carrying out the invention;

FIG. 8 illustrates in simplified plan views a conventional impedance transformer, a conventional slotted waveguide, and the inventive structure with arrows showing schematically the flow of microwave energy;

FIG. 9 illustrates another preferred embodiment of the microwave heating apparatus of the present invention in which the subcavity forms an annular region inside the periphery of a generally cylindrical applicator cavity: and,

FIG. 10 illustrates another preferred embodiment of the microwave heating apparatus of the present invention in which power is launched into the subcavity by slotted waveguides running along the length of the subcavity.

### DETAILED DESCRIPTION OF THE INVENTION

A microwave source is provided for generating a high-power microwave signal for input to the microwave cavity and to which the workpiece is subjected. In the preferred embodiments, the microwave source may employ any one of a klystron, a twystron, a magnetron, a gyrotron, or a solid-state microwave power source. These devices are all familiar to those skilled in the art of microwave system design.

A directional coupler is typically provided for detecting the direction of a signal and further directing the signal depending on the detected direction. A signal received from the microwave source is directed toward the microwave cavity. A signal received from the direction of the microwave cavity is directed toward a reflected power load. The directional coupler thus provides a means whereby reflected power is diverted away from the microwave source in order to protect the microwave source from power unabsorbed by the workpiece.

A first power meter is provided for measuring the power delivered to the microwave cavity. The first power meter is used in conjunction with a second power meter positioned to measure reflected power from the microwave cavity in order to monitor the efficiency of the microwave cavity and to insure that reflected power is dissipated in the reflected power load and not by the microwave source.

The reflected power load may also be used to test the functionality of the system by removing all workpieces from the microwave cavity, thus directing the entire signal from the microwave source into the reflected power load. Comparisons can be made of the power received by the reflected power load and the power delivered from the microwave source to determine any system losses.

The magnitude of the reflected power is measured by the second power meter. This magnitude may be used to determine the efficiency of the instant frequency of the microwave introduced into the microwave cavity. Lower reflected power indicates a more efficient operating frequency due to the higher absorption rate of the selected workpiece.

A leaky subcavity is disposed within the main furnace cavity in order to receive microwave power from a waveguide and allow that power to be spread laterally through a process of internal reflection and scattering, while at the same time allowing the power to leak into the main cavity in a relatively uniform way from along the surface of the subcavity. The subcavity may be defined by a sheet of perforated metal formed into a selected shape, using a surface of the main cavity as one boundary of the subcavity. In addition, some of the aforementioned metal sheet may be nonperforated in order to further manage the processes of reflection and scattering.

A microwave heating apparatus incorporating various features of the present invention is illustrated generally at 10 in the figures. The microwave heating apparatus 10 is designed to transmit a microwave signal into a microwave cavity for heating or other selected processes. The microwave frequency may be fixed or it may be varied over a selected bandwidth of a few percent or less.

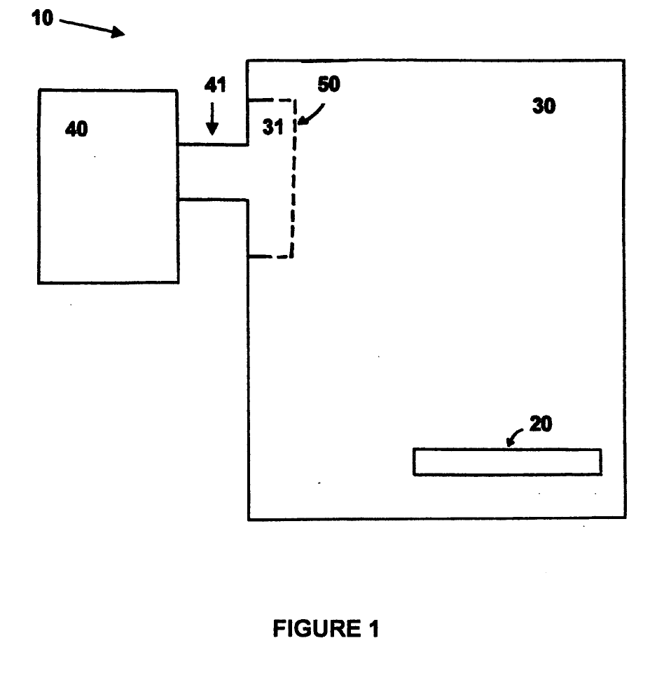

FIG. 1 illustrates schematically a preferred embodiment of the microwave heating apparatus 10 of the present invention, wherein a selected workpiece 20 is to be processed in a multimode applicator cavity 30. Microwave power is generated by a microwave source 40 and is transmitted to the cavity through a waveguide 41. A perforated metal plate 50 is attached to one wall of cavity 30 thereby forming a subcavity 31 enclosing the open end of the waveguide 41. For simplicity, details of the means of attachment are not shown. It will be well understood by those skilled in the art that any number of conventional means may be employed, such as welding, brazing, use of mechanical fasteners, etc. It will be further appreciated that the inventive perforated plate 50 may be fabricated to include incidental features such as flanges, threaded holes, and the like in order to facilitate its attachment to the wall(s) of the main applicator cavity 30. (The term workpiece as used herein includes any material placed into the cavity for microwave treatment. It may equally well include: a batch of similar components to be processed simultaneously and any carriers or fixturing associated with these components; continuous films or webs of material to be treated by passing through the cavity 30; adhesives and/or coatings to be cured; or any other material for which microwave treatment is desired.)

The edges of the perforated plate 50 may be smooth if the plate is sheared to size first and then punched, or they may be erose if the plate is punched first and then sheared. The plate may be mounted flush against the wall(s) of cavity 30, or a gap may be set in order to provide additional microwave leakage from subcavity 31 into the heating cavity 30. The plate may be fabricated from any convenient conductive sheet material such as aluminum, copper, steel, stainless steel, or the like. Alternatively, the “perforated” structure can be formed by an appropriate metallization pattern disposed upon a sheet or plate of microwave-transparent materials such as ceramics, polymers, and the like.

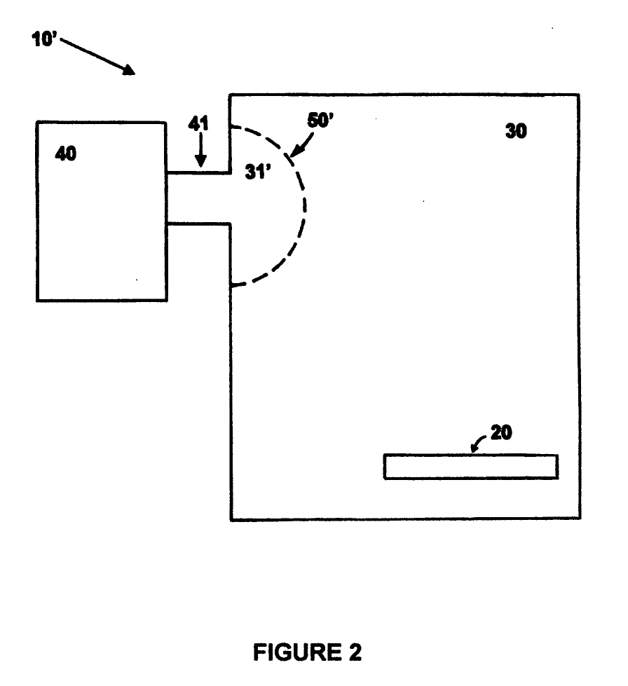

Illustrated at 10′ in FIG. 2 is another embodiment of the microwave heating apparatus. In this embodiment, the perforated metal plate 50′ is curved so that the plate 50′ and the rear wall of cavity 30 enclose a subcavity 31′ having the shape of a half-cylinder. It will be appreciated that the radius of curvature of the plate 50′ may be varied and furthermore that the plate 50′ may contact the top wall of cavity 30 thereby forming a subcavity 31′ having the general shape of a quarter-cylinder.

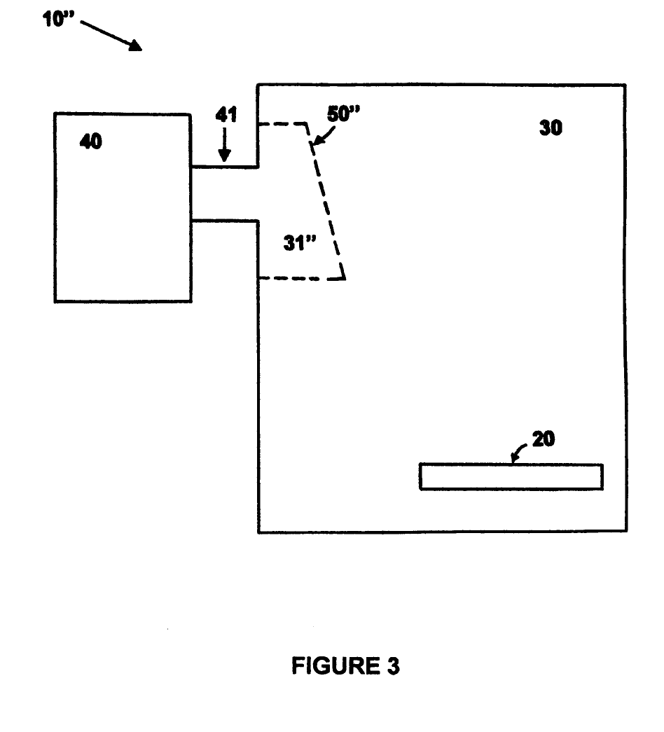

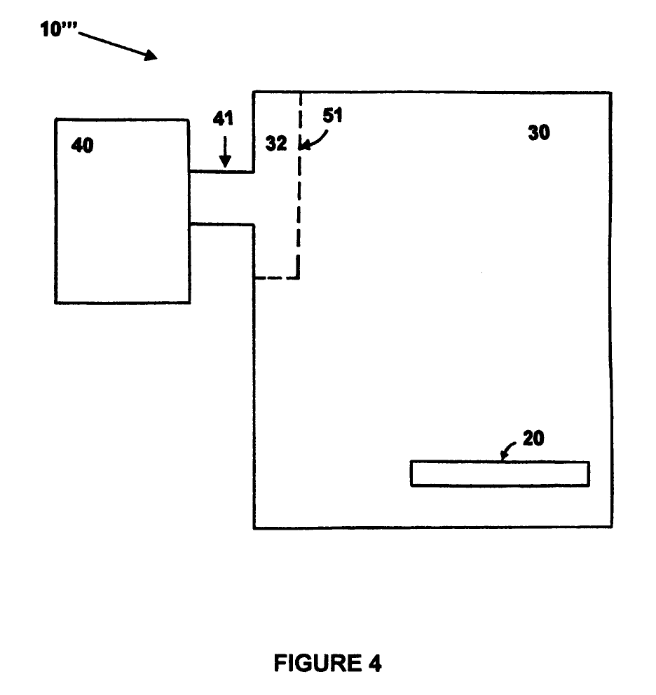

Illustrated in FIGS. 3-4 are alternate embodiments of the microwave heating apparatus 10 of the present invention. In FIG. 3 the subcavity 31″ has the shape of a trapezoidal prism. In this case, the sloping front surface of the plate 50″ makes it more difficult for the subcavity 31″ to support particular microwave modes, thereby improving the randomness of microwave energy as it leaks into the main cavity 30. In FIG. 4, two surfaces of the subcavity 32 are defined by two walls of the main cavity 30 and the other two are defined by the perforated metal plate 51.

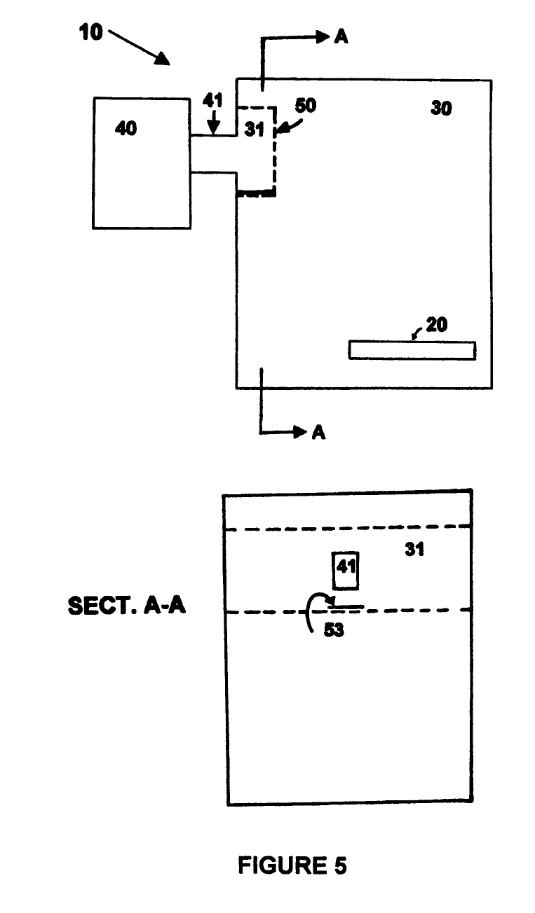

FIG. 5 illustrates a further modification of the inventive subcavity. Here, a small area of the perforated metal plate 50 is replaced (or overlaid) by a solid metal plate 53 to further diffuse the incoming microwave power from waveguide 41 in the near-field region. It will be appreciated that the solid plate 53 ideally covers a relatively small fraction of the total surface area of perforated plate 50 in order to minimize power reflected back into waveguide 41 and thereby maximize heating efficiency.

The MicroCure™ 2100 variable frequency microwave oven (Lambda Technologies, Inc., Morrisville, N.C.) has a cavity 14″ H×15″ L×19″ D and an operating frequency range of 5.3 to 7.5 GHz. The workpiece to be processed consisted of approximately 20 polymer components (˜50 g each) arranged on a flat polycarbonate carrier. With an applied power of approximately 200 W and heating for 50 s, the temperatures of the individual components ranged from 86° C. to 103° C. The pattern of observed temperature variations indicated the presence of a power concentration in the near field of the waveguide opening.

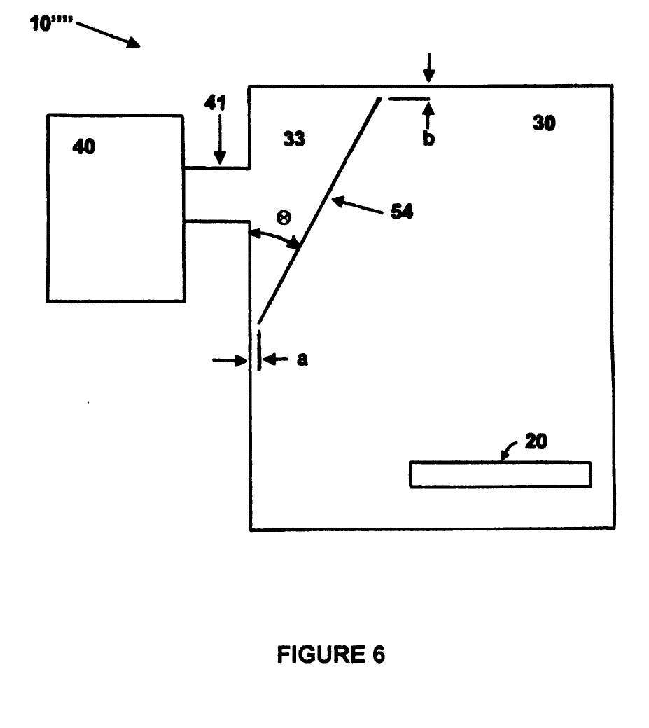

In a system similar to that in the preceding example, a metal plate was inserted in the cavity forming a subcavity in the shape of a triangular prism as illustrated in FIG. 6. It was found that by adjusting the gaps a and b, and the angle Θ, the temperature range could be changed, indicating that even this crude subcavity had some effect of spreading the power being launched into the cavity. After some experimentation, it was found that using a plate 6″ wide, with gaps a and b set at 1″ from the respective cavity walls, and the angle Θ set at 45°, the observed temperature range of the individual workpieces narrowed to 95° C. to 106° C. Applicants discovered, however, that when the workpiece was changed or repositioned within the cavity, gaps a and b, and the angle Θ for optimal uniformity also changed.

It will be understood that in many cases the plate bounding the subcavity will be fixedly mounted to the wall of the applicator. However, as the preceding example shows, in some applications it might be desirable to provide a pivoting or sliding mount, with or without mechanical actuators, whereby the perforated plate may be readily changed from one position to another. In these cases, the position of the perforated plate becomes part of the process “recipe” associated with a particular batch or type of workpiece.

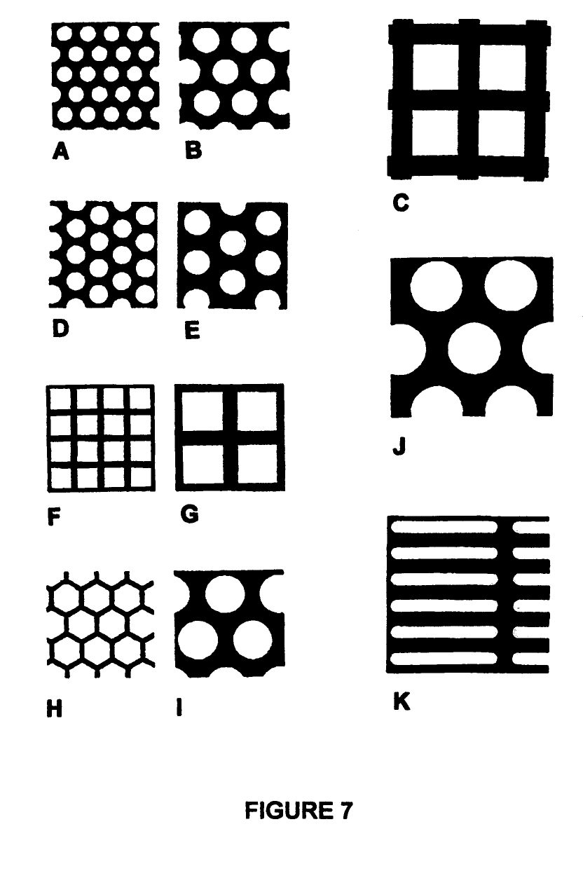

In the system of the preceding examples, a perforated plate having vertically oriented slots (⅛×1″ each with 43% open area) as illustrated in FIG. 7K was oriented at a 45° angle to the back and top walls of the cavity, thereby forming a subcavity in the shape of a triangular prism extending the full length (15″) of the main cavity. In this case, the observed temperature range of the workpieces was 86° C. to 112° C. Then, a solid plate 1.5″ high and extending the full length of the slotted plate was added to cover the bottommost portion of the slotted plate in order to deflect more of the microwave energy emerging from the waveguide opening. With this configuration, the observed temperature range of the workpieces was 92° C. to 103° C.

Building upon the foregoing results, various perforated plates were fabricated for use in a MicroCure™ 5100 oven (Lambda Technologies, Inc., Morrisville, N.C.). This oven has an applicator cavity 12″ H×45″ L×18″ D and an operating frequency range of 5.8 to 7.0 GHz. The workpiece consisted of 108 polymer components of the type used in the foregoing examples. These components were supported on three polycarbonate pallets on a conveyor within the cavity. The following Table 4 summarizes the results of testing various configurations of perforated plates. Each test consisted of twelve nominally identical heating runs, using nine instrumented workpieces in different positions so that uniformity of heating throughout the cavity could be mapped. It can be seen from the tabulated data, that the inventive structure significantly improved uniformity without sacrificing heating efficiency, provided that frequency sweeping was used over the furnace's usable bandwidth.

For comparison, a slotted waveguide was constructed using the best available design principles. None of the tested configurations of the slotted waveguide showed acceptable uniformity compared to the lossy subcavity when operated over the 5.8 to 7.0 GHz bandwidth.

TABLE 4
Heating Uniformity Results for Several Subcavity Designs

| | | | | Hole | Back- | Side- | Efficiency | Uniformity | |
|---|---|---|---|---|---|---|---|---|---|
| | | Subcavity | Radius | Dia. | gap | gap | t_{Ave}/Δt | ΔT/σ | |
| Run | Iris | Shape (note c) | (Inches) | (In.) | (In.) | (In.) | (note a) | (note b) | T_{Ave} |
| 1 | y | ½ cyl | 3.5 | 0.5 | 0.2 | 0 | 88.3/3.5 | 29.9/5.75 | 93.04 |
| 2 | y | ½ cyl | 3.5 | 0.5 | 0.2 | 0 | 103.2/1.5 | 29.0/6.80 | 103.2 |
| 3 | y | ½ cyl | 2.5 | ⅜ | 0.2 | ⅛ | 87.3/2.2 | 33.4/6.99 | 92.77 |
| 4 | y | ½ cyl | 2.5 | ⅜ | 0 | ⅛ | 97.4/3.3 | 28.2/6.01 | 93.44 |
| 5 | y | ½ cyl | 2.5 | ⅜ | 0 | ¼ | 105.9/5.9 | 30.7/6.36 | 99.42 |
| 6 | y | ½ cyl | 2.5 | ⅜ | 0.25 | ⅛ | 98.4/9 | 48.5/7.48 | 95.52 |
| 7 | y | ½ cyl | 2.5 | ⅜ | 0.2 | ⅛ | 104.1/9.9 | 35.8/6.87 | 102.8 |
| 8 | y | ½ cyl | 2.5 | ¼ | 0 | ⅛ | 192/24.8 | 35/7.68 | 101.3 |
| 9 | n | ½ cyl | 2.5 | ⅜ | 0 | ⅛ | 76.7/2.4 | 25.5/5.29 | 91.41 |
| 10 | n | ½ cyl | 2.5 | ⅜ | 0.2 | ⅛ | 81.2/6.6 | 26.9/6.31 | 94.53 |
| 11 | n | ½ cyl | 2.5 | ⅜ | 0.4 | ⅛ | X | 58.1/10.7 | 101.37 |
| 12 | n | ½ cyl | 2.5 | ¼ | 0.4 | ⅛ | X | 40.4/7.08 | 94.46 |
| 13 | n | V-shape | — | ¼ | 0.2 | ⅛ | X | 24.6/5.67 | 93.01 |
| 14 | n | V-shape | — | ⅜ | 0.2 | ⅛ | 80.2/12.9 | 50/4/9.1 | 98.6 |
| 15 | n | V-shape | — | ½ | 0.2 | ⅛ | 78.3/4.2 | 39.9/7.84 | 100.73 |
| 16 | n | Rectangle | — | ½ | 0.2 | ⅛ | 75.7/4.5 | 40/7.68 | 95.71 |
| 17 | n | V-shape | — | ¼ | 0.2 | ⅛ | 79.6/1.9 | 38.7/7.21 | 93.24 |
| 18 | n | Trapezoid - st | — | ⅜ | 0.2 | ⅛ | 73.7/4.32 | 27.9/5.3 | 85.27 |
| 19 | n | Trapezoid - sb | — | ⅜ | 0.2 | ⅛ | 76.2/6.25 | 38.9/7.07 | 90.46 |
| 20 | n | Trapezoid - st | — | ⅜ | 0.2 | ⅛ | 73.5/2.91 | 27.2/5.6 | 84.99 |
| 21 | n | Trapezoid - st | — | ¼ | 0.2 | ⅛ | 80.5/2.3 | 20.4/5.45 | 91.13 |
| 22 | n | Trapezoid - st | — | ½ | 0.2 | ⅛ | 85/1.377 | 56.4/9.12 | 107.35 |
| 23 | n | Trapezoid - sb | — | ½ | 0.2 | ⅛ | 77.2/2.22 | 50.6/8.6 | 99.59 |
| 24 | n | none | — | — | — | — | 67.7/2.02 | 60.7/12.99 | 88.34 |

a. Efficiency figures represent average time (sec) to reach target temperature and range of times (five runs)
b. Uniformity figures represent temperature range and standard deviation among individual workpieces (five runs)
c. Shapes are: a half-cylinder with flat side on rear wall; a V-shape with flat side on rear wall and 60° angle; a rectangular box; and a trapezoidal shape with a slanting front surface (st = short side top; sb = short side bottom)

It will be appreciated that the size and shape of the perforations may be varied to suit particular applications. For example, the slotted plate described previously and illustrated in FIG. 7K will be more or less reflective depending on the orientation of the slots relative to the polarization of the microwave signal. It will be further appreciated that more than one type of perforation may be combined on a single plate 50. For example, if the waveguide is oriented vertically, most of plate 50 can have vertically oriented slots for maximum efficiency. A small portion of plate 50 immediately in front of the waveguide opening might have the slots oriented horizontally to further blunt the near-field effects in a manner analogous to the solid plate 53.

Prior work, specifically the design principles and patents underlying the MicroCure™ 5100 series instruments, teaches that uniformity is greatly improved by frequency sweeping over as wide a bandwidth as possible (typically 5%). However, skilled artisans will appreciate that the cost of a microwave system is based, in part, on bandwidth. In an effort to develop lower cost systems, Applicants undertook an experimental program to determine whether the principles of the leaky subcavity could be applied to lower-cost microwave systems having relatively narrow bandwidths. As will be illustrated in the following examples, the narrow-band microwave heating system can be made more useful by employing a subcavity 31 within the main microwave cavity 30 to create a more uniform power distribution without resorting to wide bandwidth operation.

### EXAMPLE 1

To examine the effect of bandwidth on uniformity in conjunction with the inventive subcavity, a series of tests were performed using a MicroCure™ 2100 oven as described previously. A rectangular plate of uniformly lossy material was used as a test load, and in each run the plate was heated for 10 seconds at 200 W forward power, after which it was removed and immediately photographed with an IR thermal imaging camera to map the temperature distribution across its surface. All runs used a center frequency of 6.425 GHz, and frequency sweeps (±about the center frequency) of 0, 0.1438, 0.2875, or 0.575 GHz respectively.

With no subcavity installed, at fixed frequency the thermal distribution was highly nonuniform, with several distinct hot spots and a temperature range of 25-60° C. The uniformity gradually improved as bandwidth was increased and the temperature range narrowed to about 26-40° C.

The runs were then repeated using a “slanted box” subcavity as shown in FIG. 3, with ⅜″ round perforations. Table 5 shows several striking results. First, with the subcavity in place, improved uniformity is obtained versus the control at any given bandwidth. Second, even at fixed frequency, the presence of the subcavity, surprisingly, improved uniformity significantly.

TABLE 5
Heating Uniformity vs Bandwidth With and Without Subcavity Installed

| | | | Temp. |
|---|---|---|---|
| | | Visual Uniformity (IR map) | Range, ° C. |
| No Subcavity | | | |
| 6.425 | GHz | Very nonuniform | 25-60+ |
| 6.425 +/− .1438 | GHz | Slightly nonuniform | 25-50 |
| 6.425 +/− .2875 | GHz | Somewhat nonuniform | 25-60 |
| 6.425 +/− .575 | GHz | Highly uniform | 25-40 |
| Slanted Box Subcavity | | | |
| 6.425 | GHz | Slightly nonuniform | 25-50 |
| 6.425 +/− .1438 | GHz | Highly uniform | 25-40 |
| 6.425 +/− .2875 | GHz | Highly uniform | 25-40 |
| 6.425 +/− .575 | GHz | Highly uniform | 25-40 |

Those skilled in the art will appreciate that the fixed frequency test in the foregoing example is in fact a more rigorous demonstration of the value of the inventive subcavity for industrial heating systems. It is well known that nominally “fixed-frequency” microwave heating systems operating within the FCC-designated ISM bands do, in fact, have some allowable (nonzero) bandwidth, e.g., 2450±20 MHz. Thus, based on the results in EXAMPLE 1, the inventive subcavity can provide measurable benefits to magnetron-based systems operating within the ISM bands.

The experimental data in Tables 4 and 5 indicate, somewhat surprisingly, that at the frequencies used, holes as small as ¼″ diameter allowed microwave power to leak out of the subcavity 31. The holes or perforations are preferably smaller in at least one dimension than about half the microwave wavelength; however, there is a lower practical limit to the hole size below which the reflected power in the waveguide 41 will increase and heating efficiency will suffer. It will also be appreciated that diffraction occurs when the microwaves interact with the holes in the perforated plate 50. This serves to further disperse the microwave energy in numerous directions within the main cavity, whereby more of the cavity's possible modes may be driven by the microwave source.

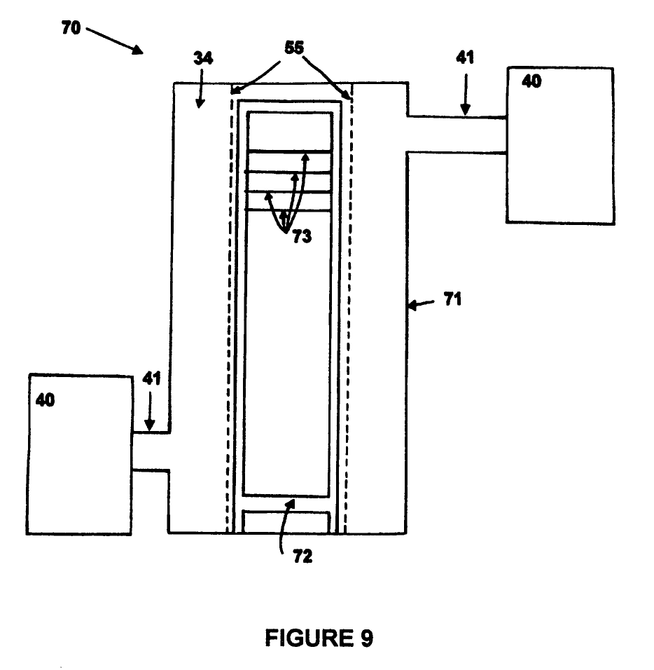

The inventive apparatus is not restricted to generally rectangular cavities as shown in FIGS. 1-6, but may also be usefully employed in generally cylindrical cavities as shown at 70 in FIG. 9. A cylindrical applicator cavity is particularly useful for simultaneously processing a large batch of silicon wafers, for example.

### EXAMPLE 2

An applicator 71 was constructed with internal dimensions of 20″ diameter×36″ high. This applicator further had flat surfaces about 6″ wide running lengthwise at various locations around its circumference to provide convenient attachment points for the input waveguides. A cylindrical perforated metal sheet 55 approximately 11″ diameter×36″ high was placed inside, thereby forming a subcavity 34 having a generally annular shape. The diameter of this perforated plate was chosen to accommodate the outside dimensions of a wafer boat 72 holding 25 standard 8″ silicon wafers 73 (several of which are shown in the drawing). Microwave power was supplied by three 700 W C-band amplifiers 40 and fed through three separate waveguides 41 (two of which are shown for simplicity). Thus, all of the microwave power was launched into the same annular subcavity, but at several locations around the circumference and at different heights as indicated schematically in the figure. Three separate processes of interest have target temperatures of 275, 350, and 500° C. respectively. Heating experiments with and without the inventive subcavity clearly showed that the use of the subcavity greatly improved thermal uniformity across each individual wafer and from one wafer to another.

It will be appreciated that the dimensions of the apparatus described in the foregoing example were specifically chosen to accommodate one standard wafer size. Other wafer sizes are also known in the art and it will be clear that the apparatus can easily be scaled to larger dimensions to heat 12″ wafers, for instance.

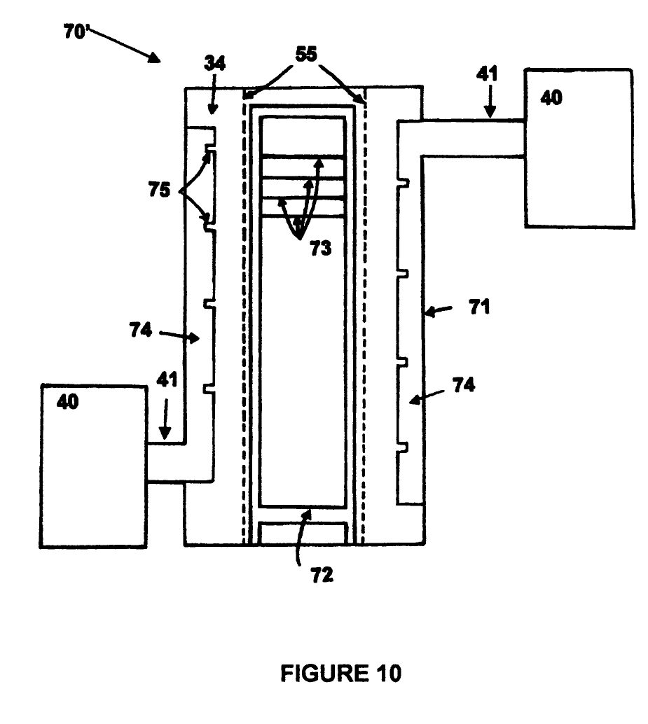

As discussed earlier, heating uniformity obtained using a slotted waveguide instead of the inventive subcavity was generally not acceptable, in part because the slotted waveguide is an inherently narrow-band device. However, Applicants' discovery that the inventive subcavity can be used in narrow-band systems (EXAMPLE 1) then led Applicants to reconsider the potential role of slotted waveguides. Applicants therefore conducted a further analysis indicating the slotted waveguide and the leaky subcavity may be combined to provide still further benefits. The reasoning is as follows. On one hand, capital costs can be reduced if a high power klystron is used as the microwave source (instead of a TWT, for example). On the other hand, such a high-power and relatively narrow-band source might create near-field effects that are greater than the subcavity alone can eliminate. A combination of the two approaches is illustrated at 70′ in FIG. 10 and described in the following example.

### EXAMPLE 3

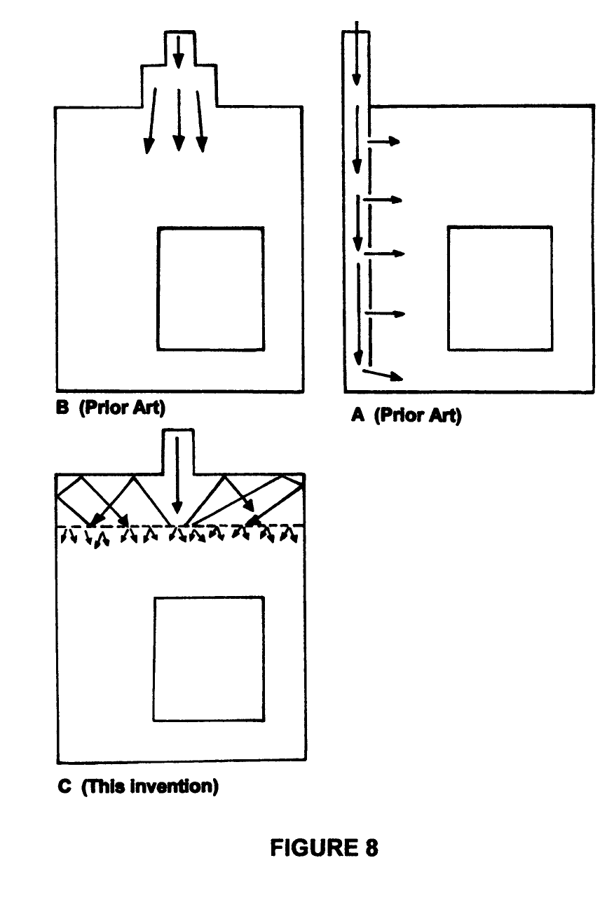

FIG. 10 shows a generally cylindrical applicator 71 with a generally annular subcavity 34 similar to that in EXAMPLE 2. Microwave power enters through one or more slotted waveguides 74 that run lengthwise within the subcavity 34. Thus, the slots 75 provide a first means of distributing energy, by providing multiple launch points along the length of the subcavity. The perforated boundary 55 of the subcavity 34 then provides a second means of further dispersing this energy so that greater uniformity may be achieved, as suggested by consideration of the schematic radiation patterns indicated in FIGS. 8A and 8C.

The apparatus shown in FIG. 10 has slotted waveguides running axially at several locations around the circumference of the cavity, with slots at various heights. Those skilled in the art will appreciate that a similar effect may be achieved by arranging several slotted waveguides running circumferentially (each at a different height). In this case, the slots would serve to introduce the power at different locations around the circumference and the respective axial locations of the individual waveguides would serve distribute energy axially. Yet another variation of this approach would employ a single slotted waveguide disposed in a generally helical shape from one end of the cavity to the other, each successive slot therefore occupying a different radial and axial position along the periphery of the cavity. Where multiple slotted waveguides are used, it will be understood that they may operate at the same frequency or at different frequencies.

It will be seen from the foregoing that the inventive “leaky subcavity” offers an extremely wide range of design options to allow for optimizing the system for a given cavity size and frequency range. At the same time, the subcavity is inexpensive and easily manufactured.

For simplicity, the systems shown in FIGS. 1-6 each contain a single microwave source and waveguide. Applicants have shown that the inventive concept can be applied equally well to systems having more than one microwave source and/or more than one input waveguide as shown in FIGS. 9-10. When more than one waveguide is used, several waveguides may input power to the same subcavity, or each may have its own subcavity depending on overall power, frequency, applicator size, and other familiar engineering considerations.

As used herein, the term “fixed frequency” includes devices such as klystrons, gyrotrons, and magnetrons that may be tunable to some degree but once tuned are normally operated at a relatively constant nominal frequency. It will be understood that the operating frequency of such devices may exhibit small variations such as thermal drift, noise, harmonic content, etc.

In the drawings and the corresponding discussion, the waveguide is represented as opening into the subcavity. It is important to note that Applicants intend for this to mean an “opening” in the electrical sense. That is, although not shown in the drawings, a microwave-transparent dielectric window may be placed in the area where the waveguide meets the cavity wall as would be well understood by those skilled in the art. The use of such a window might be desirable, for example, when the applicator cavity must contain a vacuum, reactive gases, etc., and the presence or absence of a window is immaterial to the claimed inventive concept.

The inventive microwave processing system may further contain various instruments, diagnostics, control systems, and accessories as are well known to microwave furnace designers. Some of these features include: vacuum or gas-handling systems; contacting or noncontacting temperature measurement systems such as thermocouples, fiber optic sensors, and infrared detectors; positioning fixtures, conveyors, or robotic handlers; microprocessor-based process controls; and microwave seals, interlocks, leakage detectors, and other safety features.

While several preferred embodiments have been shown and described, and several embodiments which have been constructed and tested have been specifically delineated, it will be understood that such descriptions are not intended to limit the disclosure, but rather it is intended to cover all modifications and alternate methods falling within the spirit and the scope of the invention as defined in the appended claims or their equivalents.

1. An apparatus for microwave processing of selected materials, said apparatus comprising:
a microwave source having a maximum frequency range less than about ±3% of a selected center frequency;
a multimode applicator cavity;
a transmission line from said microwave source to said microwave cavity, said transmission line including a waveguide opening into a first wall of said cavity; and,
a metallic structure enclosing a selected volume of said cavity around said opening, said structure and said first wall thereby defining the boundary of a multimode subcavity, said boundary surface being partially reflective and partially transmissive to microwave energy, whereby the microwave power may be introduced more uniformly into said applicator cavity.

2. The apparatus of claim 1 wherein said frequency range is about ±40 MHz around a selected microwave frequency.

3. The apparatus of claim 1 wherein said frequency range is 2.45 GHz ±20 MHz.

4. The apparatus of claim 1 wherein said metallic structure comprises a metal plate having a plurality of perforations, said perforations having at least one characteristic dimension that is smaller than one-half of the wavelength of said microwave frequencies.

5. The apparatus of claim 4 wherein said perforations have a shape selected from the group consisting of circles, squares, and hexagons.

6. The apparatus of claim 4 wherein at least some of said perforations comprise slots that are elongated in one dimension.

7. The apparatus of claim 6 wherein at least some of said elongated slots are oriented at a selected angle with respect to the polarization of said microwaves as said microwaves emerge from said waveguide opening.

8. The apparatus of claim 1 wherein said multimode subcavity has at least one dimension that is larger than the wavelength of said microwave frequencies.

9. The apparatus of claim 8 wherein said multimode subcavity is elongated in one dimension, thereby forming the shape of a prism whose cross section is selected from the group consisting of triangles, parallelograms, regular polygons, irregular polygons, circles, and sections thereof.

10. The apparatus of claim 4 wherein a selected portion of said metallic structure is not perforated.

11. The apparatus of claim 1 further including a means of measuring the temperature of said materials during processing.

12. The apparatus of claim 1 wherein said transmission line further includes a slotted waveguide extending into said subcavity whereby power is introduced into said subcavity at a plurality of locations.

13. An apparatus for microwave processing of selected materials, said apparatus comprising:
a multimode microwave applicator cavity;
a microwave source operating at a substantially fixed frequency;
a workpiece of a selected material to be processed;
a transmission line from said microwave source to said microwave cavity, said transmission line including a waveguide opening into a first wall of said cavity; and,
a metallic structure enclosing a selected volume of said cavity around said opening, thereby defining the boundary of a multimode subcavity, said boundary surface being partially reflective and partially transmissive to microwave energy, whereby the microwave power may be introduced more uniformly into said applicator cavity.

14. The apparatus of claim 13 wherein said microwave source comprises a vacuum tube selected from the group consisting of magnetrons, klystrons, and gyrotrons.

15. The apparatus of claim 13 wherein said microwave source comprises a solid state microwave power supply.

16. The apparatus of claim 13 wherein said metallic structure comprises a metal plate having a plurality of perforations, said perforations having at least one characteristic dimension that is smaller than one-half of the wavelength of said microwave frequencies.

17. The apparatus of claim 16 wherein said perforations have a shape selected from the group consisting of circles, squares, and hexagons.

18. The apparatus of claim 16 wherein at least some of said perforations comprise slots that are elongated in one dimension.

19. The apparatus of claim 18 wherein at least some of said elongated slots are oriented at a selected angle with respect to the polarization of said microwaves as said microwaves emerge from said waveguide opening.

20. The apparatus of claim 13 wherein said multimode subcavity has at least one dimension that is larger than the wavelength of said microwave frequencies.

21. The apparatus of claim 20 wherein said multimode subcavity is elongated in one dimension, thereby forming the shape of a prism whose cross section is selected from the group consisting of triangles, parallelograms, regular polygons, irregular polygons, circles, and sections thereof.

22. The apparatus of claim 16 wherein a selected portion of said metallic structure is not perforated.

23. The apparatus of claim 13 further including a means of measuring the temperature of said workpiece during processing.

24. The apparatus of claim 13 wherein said transmission line further includes a slotted waveguide extending into said subcavity whereby power is introduced into said subcavity at a plurality of locations.

25. A method for microwave processing of selected materials comprising the steps of:
a. placing said material in a multimode microwave applicator cavity, said cavity containing a subcavity having a boundary that is partly reflective and partly transmissive to microwave energy; and,
b. introducing microwave energy with a frequency range less than about ±3% of a selected center frequency into said subcavity from which said microwave energy can pass through said partially transmissive boundary and into said applicator cavity, whereby said material may be more uniformly exposed to said microwave energy.

26. The method of claim 25 wherein said frequency range is about ±40 MHz around a selected microwave frequency.

27. The method of claim 25 wherein said frequency range comprises 2.45 GHz ±20 MHz.

28. The method of claim 25 wherein said partially transmissive boundary comprises a metal plate having a plurality of perforations, said perforations having at least one characteristic dimension that is smaller than one-half of the wavelength of said microwave frequencies.

29. The method of claim 28 wherein said perforations have a shape selected from the group consisting of circles, squares, and hexagons.

30. The method of claim 28 wherein at least some of said perforations comprise slots that are elongated in one dimension.

31. The method of claim 30 wherein at least some of said elongated slots are oriented at a selected angle with respect to the polarization of said microwaves as said microwaves emerge from said waveguide opening.

32. The method of claim 25 wherein said multimode subcavity has at least one dimension that is larger than the wavelength of said microwave frequencies.

33. The method of claim 32 wherein said multimode subcavity is elongated in one dimension, thereby forming the shape of a prism whose cross section is selected from the group consisting of triangles, parallelograms, regular polygons, irregular polygons, circles, and sections thereof.

34. The method of claim 28 wherein a selected portion of said metal plate is not perforated.

35. The method of claim 25 further including a means of measuring the temperature of said workpiece during processing.

36. The method of claim 25 wherein microwave energy is introduced into said subcavity at a plurality of locations by means of a slotted waveguide extending into said subcavity.

37. A method for microwave processing of selected materials comprising the steps of:
a. placing said material in a multimode microwave applicator cavity, said cavity containing a subcavity having a boundary that is partly reflective and partly transmissive to microwave energy; and,
b. introducing microwave energy at a substantially fixed frequency into said subcavity from which said microwave energy can pass through said partially transmissive boundary and into said applicator cavity, whereby said material may be more uniformly exposed to said microwave energy.

38. The method of claim 37 wherein said microwave energy is provided by a vacuum tube selected from the group consisting of magnetrons, klystrons, and gyrotrons.

39. The method of claim 37 wherein said microwave energy is provided by a solid-state microwave power supply.

40. The method of claim 37 wherein said partially transmissive boundary comprises a metal plate having a plurality of perforations, said perforations having at least one characteristic dimension that is smaller than one-half of the wavelength of said microwave frequencies.

41. The method of claim 40 wherein said perforations have a shape selected from the group consisting of circles, squares, and hexagons.

42. The method of claim 40 wherein at least some of said perforations comprise slots that are elongated in one dimension.

43. The method of claim 42 wherein at least some of said elongated slots are oriented at a selected angle with respect to the polarization of said microwaves as they emerge from said waveguide opening.

44. The method of claim 37 wherein said multimode subcavity has at least one dimension that is larger than the wavelength of said microwave frequencies.

45. The method of claim 44 wherein said multimode subcavity is elongated in one dimension, thereby forming the shape of a prism whose cross section is selected from the group consisting of triangles, parallelograms, regular polygons, irregular polygons, circles, and sections thereof.

46. The method of claim 40 wherein a selected portion of said metallic structure is not perforated.

47. The method of claim 37 further including a means of measuring the temperature of said workpiece during processing.

48. The method of claim 37 wherein microwave energy is introduced into said subcavity at a plurality of locations by means of a slotted waveguide extending into said subcavity.
